(19) United States
(12) Patent Application Publication
(10) Pub. No.: US 2009/0154901 A1
(43) Pub. Date: Jun. 18, 2009

(54) METHOD AND APPARATUS FOR REPRODUCING DATA

(75) Inventors: Kwang-min KIM, Seoul (KR); Kil-soo Jung, Osan-si (KR); Joon-hwan Kwon, Suwon-si (KR); Eun-mi Lee, Seoul (KR); Hye-young Jun, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/188,282

(22) Filed: Aug. 8, 2008

(30) Foreign Application Priority Data
Dec. 12, 2007 (KR) 2007-128755

(51) Int. Cl. H04N 7/26

(52) U.S. Cl. 386/124; 386/E05.001

(57) ABSTRACT

A method and apparatus for reproducing data. The method includes downloading data in a local storage; and reproducing the data according to a predetermined reproduction order, wherein when data that is to be reproduced next has not yet been downloaded, the reproducing of the data according to the predetermined reproduction order includes: stopping data reproduction; and when downloading the data that is to be reproduced next is completed, reproducing data from the location where data reproduction stopped.

### CROSS-REFERENCE TO RELATED APPLICATION

This application claims the benefit of Korean Patent Application No. 2007-128755, filed Dec. 12, 2007 in the Korean Intellectual Property Office, the disclosure of which is incorporated herein by reference.

### BACKGROUND OF THE INVENTION

1. Field of the Invention

Aspects of the present invention relate to a method and apparatus for reproducing data, and more particularly, to a method and apparatus for reproducing data downloaded from an external server.

2. Description of the Related Art

An optical disc, on which large amounts of data can be recorded, is widely used as a recording medium. An apparatus for reproducing data reproduces data from a loaded recording medium, such as a digital versatile disc (DVD) or a blue-ray disc (BD). Such an apparatus separately includes a local storage besides a part on which the recording medium is loaded. The local storage can store downloaded data once the apparatus is connected to a network server that stores data. Accordingly, the apparatus can reproduce data recorded on the loaded recording medium or independently reproduce data stored in the local storage. Alternatively, the apparatus can create and reproduce new data by mixing the data recorded on the recording medium and the data stored in the local storage.

The apparatus can download audio/video (AV) data or an application program, apart from the data recorded on the recording medium, into the local storage. When the apparatus downloads AV data from an external server, the apparatus can download full data that is to be reproduced in a clip unit by using a playlist. When the playlist is a progressive playlist and the apparatus has downloaded some clips from among the data that is to be reproduced, the apparatus can reproduce the downloaded clips while continuously downloading the remaining clips. If a clip that is to be reproduced next according to a reproduction order in the playlist has not yet been downloaded, the apparatus notifies a user or an application, and stops reproducing the data. In this case, the user has to request the apparatus to again reproduce the downloaded data. The apparatus reproduces the data not from the location where the reproduction has stopped, but from the beginning of the data, causing inconvenience to the user.

### SUMMARY OF THE INVENTION

Aspects of the present invention provide a method and apparatus for reproducing data, which, when data that is to be reproduced cannot be reproduced since the data has not yet been downloaded in a local storage or not yet been activated, provide independent data separate from the data to a user during the time consumed to reproduce the data.

Aspects of the present invention also provide a method and apparatus for reproducing data, which, when data that is to be reproduced has not yet been downloaded in a local storage, stops reproduction and automatically reproduces the data after the data to be reproduced is downloaded.

According to an aspect of the present invention, a method of reproducing data is provided. The method includes downloading data to a local storage; and reproducing the downloaded data according to a predetermined reproduction order and a virtual file system created to reflect the downloaded data, wherein if data that is to be reproduced next has not yet been downloaded, the reproducing of the data according to the predetermined reproduction order includes stopping data reproduction; detecting a location at which the data reproduction stopped; and reproducing data from the location where data reproduction stopped once downloading the data that is to be reproduced next is completed.

According to another aspect of the present invention, the reproducing of the data according to a predetermined reproduction order further includes reproducing additional data that is pre-stored in the local storage after stopping the data reproduction; and stopping the reproducing of the additional data once the downloading of the data that is to be reproduced next is completed. The downloading of data in a local storage may include storing the data independently from the additional data in the local storage. The data reproduction may be performed according to a progressive playlist unit, and the stopping of data reproduction may comprise stopping the reproducing of the clip AV streams if a clip AV stream that is to be reproduced next from among clip AV streams assigned by a playitem included in a progressive playlist has not yet been downloaded. The stopping of data reproduction may include storing information about a reproduction location of a clip AV stream that was last reproduced before stopping the data reproduction; wherein the reproducing of data from the location where data reproduction stopped may include reproducing the clip AV stream that is to be reproduced next from the reproduction location by using the information about the reproduction location. The method may further include generating a virtual file structure to reproduce data read from a recording medium; and when the data is downloaded in the local storage, updating the virtual file structure, wherein the reproducing of the data comprises extracting a reproduction order of clip AV streams from the progressive playlist in the updated virtual file structure, and reproducing the clip AV streams according to the reproduction order.

According to another aspect of the present invention, an apparatus to reproduce data is provided. The apparatus includes a local storage to store data downloaded from an external server; and a controller to reproduce the data stored in the local storage according to a predetermined reproduction order and a virtual file system that reflects the downloaded data; wherein, when data that is to be reproduced next has not been downloaded, the controller stops data reproduction, detects a location at which the data reproduction stopped, and reproduces the data that was being stopped from the detected location once the data that is to be reproduced next is downloaded.

According to another aspect of the present invention, a computer readable recording medium is provided, having recorded thereon a program to executing a method of reproducing data. The method includes downloading data to a local storage; and reproducing the data according to a predetermined reproduction order and a virtual file system; wherein, if data that is to be reproduced next has not yet been downloaded, the reproducing of the data according to the predetermined reproduction order includes stopping data reproduction; detecting a location at which the data reproduction stopped; and reproducing data from the location where data reproduction stopped once the downloading of the data that is to be reproduced next is completed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a multimedia data structure for reproducing a moving image, according to an embodiment of the present invention;

FIG. 2 is a diagram of a virtual file system according to an embodiment of the present invention;

FIG. 3 is a block diagram of an apparatus for reproducing data, according to an embodiment of the present invention;

FIG. 4 is a diagram of a progressive playlist; and

FIG. 5 is a flowchart of a process of reproducing data according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

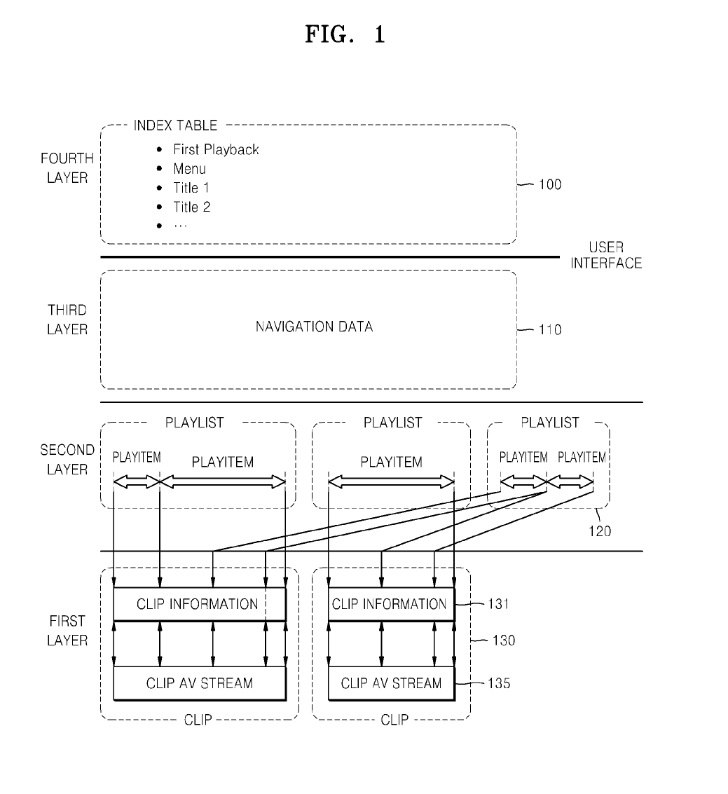

FIG. 1 shows a multimedia data structure for reproducing a moving image, according to an embodiment of the present invention. Multimedia data for reproducing a moving image, such as a high definition movie, can be classified into first to fourth layers. The layers each include a clip 130, which is a record unit of the multimedia data; a playlist 120, which is a reproduction unit of the multimedia data; navigation data 110, which includes a navigation command for reproducing the multimedia data; and an index table 100, which assigns multimedia data that is to be first reproduced and each title. Each layer may also include additional data besides the clip 130, playlist 120, navigation data 110, and index table 100. The structure may also be compatible with a Blu-ray or Blu-ray compliant disc data structure as set forth in the Blu-ray specification.

The clip 130 in the first layer is an object by which an AV data stream for the high definition movie and a characteristic of the corresponding AV data stream can be realized. Moving image data is recorded in a unit of the clip 130 in a continuous space of a recording medium. Hereinafter, the AV data stream is referred to as a clip AV stream 135 and information about the characteristic of the AV data stream is referred to as clip information 131. The clip AV stream 135 may include at least one among a presentation graphic stream, which provides a video stream, an audio stream, and a sub title; and an interactive graphic stream, which provides a menu for interaction with a user. The clip information 131 includes, for example, information about a characteristic of the clip AV stream 135 and an entry point map for converting reproduction time information to byte address information.

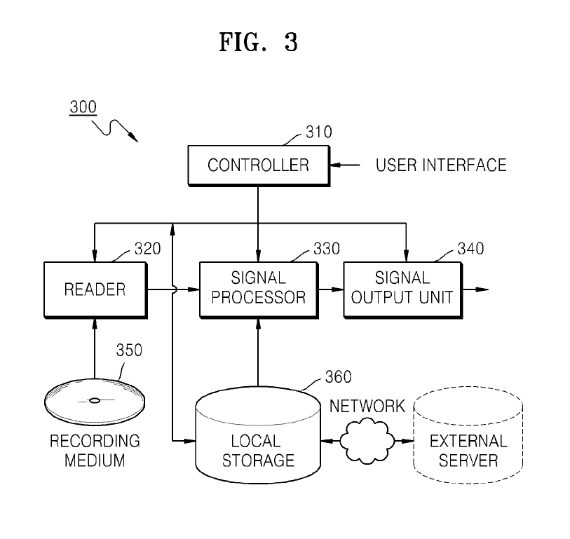

The playlist 120 in the second layer indicates a reproduction unit where a part of or a plurality of clips 130 is/are reproduced at once, and is formed of a reproduction unit called a playitem that assigns a reproduction interval in the part of or the plurality of clips 130 that is/are to be reproduced. The playlist 120 determines a reproduction order in order to sequentially reproduce a plurality of playitems, or to selectively reproduce a predetermined playitem from among a plurality of playitems according to a user or a basic set up of an apparatus for reproducing data. The apparatus for reproducing data reproduces the clip 130 assigned by the playitem according to the reproduction order of the playitems included in the playlist 120. The apparatus may be, for example, the apparatus 300 shown in FIG. 3, although other reproducing and/or recording apparatuses may also be employed.

The navigation data 110 in the third layer includes navigation data in a core mode, and navigation data in a full mode (hereinafter respectively referred to as ‘core mode navigation data’ and ‘full mode navigation data’). The core mode navigation data may include a movie object, and the full mode navigation data may include application objects. The core mode or a movie mode is a mode where a manufacturer reproduces a moving image according to an assigned time. The full mode is a mode where the manufacturer reproduces a moving image data with an application that has a program function. In case of the full mode, a moving image may be provided with a program application using C language, Java, HTML, script language, or the like. The navigation data 110 includes navigation command programs and navigation commands to start reproducing the playlist 120 or to manage reproduction of the playlist 120 according to a user preference.

The index table 100 in the fourth layer is a table of the top layer, which defines a plurality of titles and a menu. The index table 100 includes startup information, which is information about a media object that is initially reproduced when a recording medium, such as a disc, is loaded in the apparatus, and start location information of the plurality of titles, and start location information of the menu. When a new title is selected through the user input, a menu selection, or a navigation command, the apparatus checks the information of the plurality of titles in the index table, and reproduces the moving image according to the information.

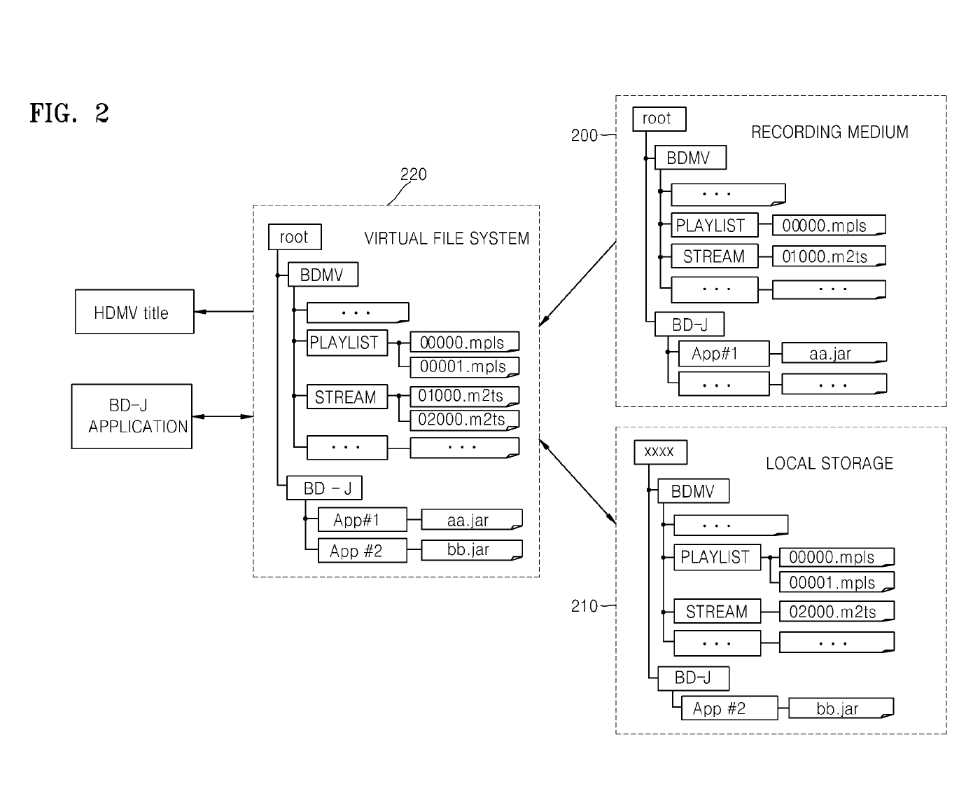

FIG. 2 shows a virtual file system 220 according to an embodiment of the present invention. FIG. 2 shows a directory 200 recorded on a recording medium, and a directory 210 stored in a local storage. Thus, the virtual file system 220 formed of the directory 200 and the directory 210. The directory 200 (shown as a BDMV directory) includes directories for the index table 100, the navigation data 110, the playlist 120, the clip information 131, the clip AV stream 135, and other data. A BD-J application directory, which stores application data for a programming function and is a lower directory of a root directory, includes a directory for an application ID and actual data of an application program. Here, the directories may also include other types of information, such as application data, image data, or markup language documents, and can be utilized in other contexts instead of, or in addition to, the Blu-ray example shown in FIG. 2. Similarly, the virtual file system may include directories in addition to than those described.

The data described above can all be downloaded, but for the convenience of description, only a playlist, a clip AV stream, and application data are downloaded as described herein by way of example. When a Java application for downloading included in the application data is executed, a file can be downloaded from an external server or a database through a network, and the file can be reproduced with moving image data recorded on a recording medium. Only one file from among a clip AV stream file, a playlist file, and another application file may be downloaded so as to replace the file to be reproduced in the recording medium. Alternatively, a clip AV stream file, a playlist file, and another application file can be downloaded in one unit so as to be added to files in the recording medium. Also, the downloaded files are stored in a local storage either in the reproducing apparatus or connected to the reproducing apparatus.

The directory 210 may have the same structure as the directory 200 so that downloaded data can be easily connected to files stored in the recording medium. A reproducing apparatus, such as the reproducing apparatus 300 shown in FIG. 3, generates a new virtual file system 220 using the directory 200 and the directory 210. After generating the virtual file system 220, the apparatus reproduces an AV stream stored in the recording medium or the local storage by referring to the virtual file system 220. Accordingly, the virtual file system 220 has the same structure as the file and directory structure of the recording medium. When predetermined data is to be reproduced in the apparatus, the apparatus determines the location of actual data corresponding to the predetermined data by checking the directory of the virtual file system 220, and reproduces the actual data by reading the actual data from the recording medium or the local storage storing the actual data. The apparatus may reproduce the actual data by managing directory information about content stored in each of the recording medium and the local storage through the virtual file system 220, or by managing the directory information as one file.

FIG. 3 shows an apparatus 300 to reproduce data, according to an embodiment of the present invention. The apparatus 300 may be, for example, a home entertainment device, a computer, a personal media player, or a mobile device, and may be connected to a network by a wired and/or a wireless connection. The apparatus 300 includes a controller 310, a reader 320, a signal processor 330, a signal output unit 340, and a local storage 360. As occasion demands, the apparatus 300 may further include an independent memory (not shown) separately from a recording medium 350, such as (BD), and the local storage 360 (such as a hard drive or recordable optical disc). According to other aspects of the present invention, the apparatus 300 may include additional and/or different units, such as an integrated display. Similarly, the functionality of two or more of the above units may be integrated into a single component. The apparatus 300 may also record data to the recording medium 350 and/or the local storage 360.

When the recording medium 350 is loaded on the apparatus 300, the reader 320 reads data from the recording medium 350, and transmits the read data to the signal processor 330. The local storage 360 downloads and stores data from an external server through a wired or wireless communication network. The local storage 360 may also pre-store additional data. Such additional data is independent from data that a user wishes to reproduce, and may be pre-downloaded by a user or pre-prepared by a manufacturer of the apparatus 300. The additional data is temporarily provided to a user when the user requests to reproduce predetermined data but the predetermined data is not reproduced since the predetermined data has not yet been downloaded or not activated. The additional data may be reproduced until the predetermined data is completely downloaded. The local storage 360 transmits the downloaded data to the signal processor 330. The signal processor 330 decodes data read by the reader 320 from the recording medium 350 or external data stored in the local storage 360, restores the decoded data to a signal, and transmits the restored signal to the signal output unit 340. The local storage 360 may also include a processor to control such downloading functions, or may be directly controlled by the controller 310.

The controller 310 controls the apparatus 300 so that a process of reproducing data according to aspects of the present invention is executed. When the recording medium 350 is loaded on the apparatus 300, the controller 310 controls the apparatus so that the apparatus 310 generates the virtual file system 220 by extracting the directory 200 stored on the recording medium 350 or read by the reader 320. Upon receiving a user command, the controller 310 downloads data from an external server or an external database, stores the downloaded data in the local storage 360, and generates a new virtual file system 220 by combining the directory 200 recorded on the recording medium 350 and the directory 210 stored in the local storage 360.

When the playlist 120 is a progressive playlist and only partial data from among data to be reproduced is downloaded to the local storage 360, the apparatus 300 can first reproduce the downloaded partial data while downloading the remaining data. The controller 310 reproduces clip AV data 130 according to a reproduction order included in the playlist 120. The controller 310 reads the playlist 120 using the navigation data 110, and determines reproduction order and time of a playitem. As described above, the playlist 120 includes a reproduction order for a sequence of a plurality of playitems to be reproduced. In some cases, the apparatus 300 may reproduce a predetermined playitem from among the plurality of playitems according to the user or a reproduction order basically set up in the apparatus 300.

The controller 310 converts time information into byte address information by reading the clip information 131 corresponding to the reproduction time according to the reproduction order, and reproduces a moving image by reading the clip AV stream 135 corresponding to the byte address information. If the clip AV stream 135 that is to be reproduced next has not yet been downloaded, the controller 310 stops data reproduction, and extracts and reproduces the additional data pre-stored in the local storage 360 or in the separate memory. The apparatus 300 can thus output the pre-stored additional data instead of data that cannot be reproduced since the data hasn't been downloaded yet, until downloading of the data is completed. The controller 310 may store information about a reproduction point that was last reproduced before stopping the data reproduction.

As described above, the clip information 131 includes the characteristic of the clip AV stream 135 and the reproduction time information, and thus the controller 310 can extract and store information about the reproduction time of a clip AV stream 135 that was last reproduced from the clip information 131 corresponding to clip AV stream 135. When the data that is to be reproduced next is downloaded, the controller 310 stops reproducing the additional data and reproduces the downloaded data. The controller 310 extracts information about a reproduction location of the clip AV stream 135 that was last reproduced, and continues to reproduce the clip AV stream 135 from a location corresponding to the extracted information. When an error occurs while reproducing or downloading data that from the external server, such as lost or altered data, and the data thus cannot be reproduced, the additional data separately stored in the local storage 360 or stored in the memory is reproduced. For example, the additional data could be a screen saver, an animation, a game, an image file, a sound, or item to be displayed while the remainder of the data to be reproduced next is downloaded.

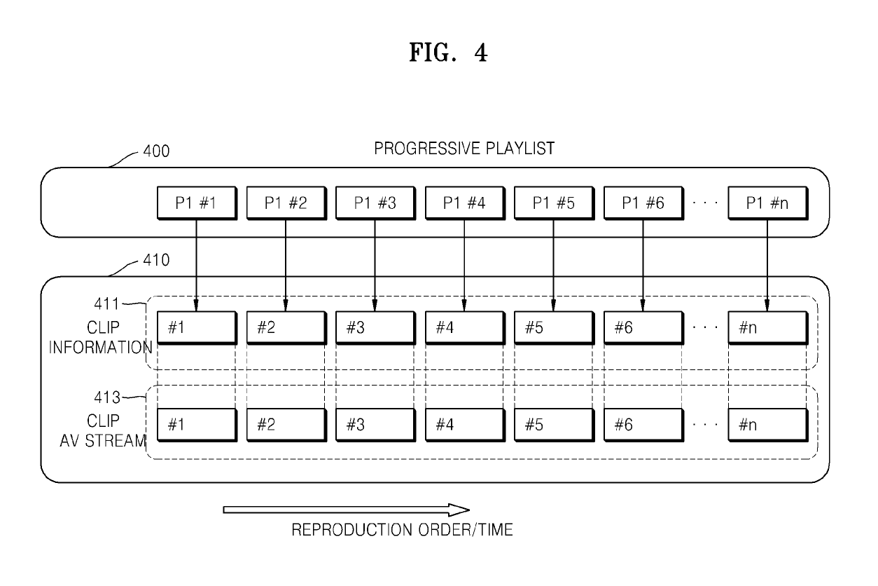

FIG. 4 shows a progressive playlist 400. A playlist that can be reproduced using the local storage 360 can be classified into two types. In a first type, reproduction is possible only after full data that is reproduced by a playlist is downloaded, and in a second type, reproduction is possible even if full data is not downloaded, and downloaded data is reproduced while downloading remaining data. As described herein, the second type is called a progressive playlist. The progressive playlist 400 can reproduce downloaded clip AV streams even when clip AV streams corresponding to a playitem included in the progressive playlist are not fully downloaded. As shown in FIG. 4, the progressive playlist 400 includes N clips 410 that are to be reproduced, where n is a natural number. When clip AV streams 413 including #1 data through #n data and only some clip AV streams 413, i.e., from #1 data to #3 data, are downloaded, the apparatus 300 can reproduce the downloaded clip AV streams 413 while downloading the clip AV streams 413 from #4 data to #n data.

When the apparatus 300 tries to reproduce the #4 data of the clip AV stream 413 according to a reproduction order included in the playlist 400, the #4 data of the clip AV stream 413 may not be reproduced, since the #4 data of the clip AV stream 413 has not yet been downloaded to the local storage 360, or is not activated due to an error. In this case, the controller 310 stops reproducing the clip AV stream 413, extracts pre-stored additional data from the local storage 360 or the memory, and transmits the extracted additional data to the signal output unit 340. The controller 310 stores information about a reproduction point or reproduction location of the clip AV stream 413 that was last reproduced before stopping the reproduction. The controller 310 may store information about a last reproduction point of #3 data of the clip AV stream 413 using information about #3 data of the clip information 411 corresponding to the #3 data of the clip AV stream 413. When downloading of the #4 data of the clip AV stream 413 is completed, or data reproduction is possible since the error is no longer occurring, the controller 310 stops reproducing the additional data and extracts information about the clip AV stream 413 that was last reproduced, using the information about the #3 data of the clip information 411. The controller 310 determines that the #3 data of the clip AV stream 413 was last reproduced, identifies the location where the reproduction stopped in the #3 data of the clip AV stream 413, and starts the data reproduction from the location where the reproduction stopped.

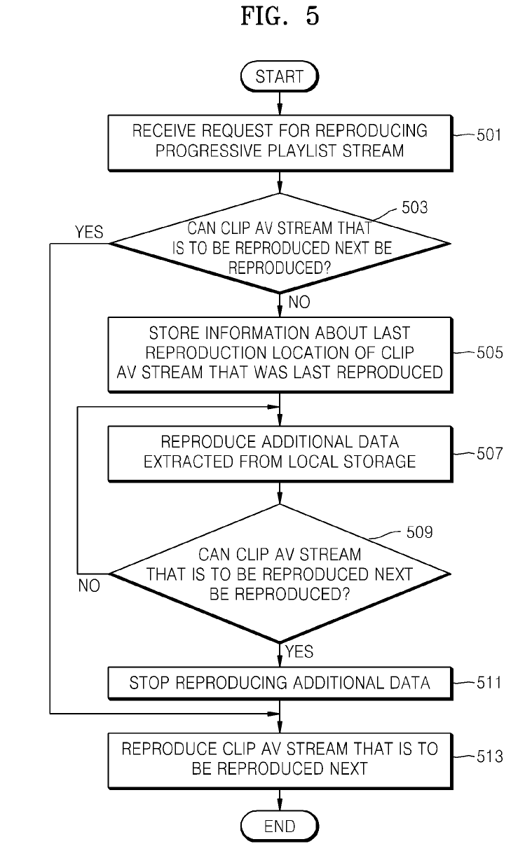

FIG. 5 is a flowchart of a process of reproducing data according to an embodiment of the present invention. The apparatus 300 receives a request from a user to reproduce a progressive playlist stream in operation 501. The apparatus 300 sends a request for needed data to a connected external server through a communication network. The local storage 360 of the apparatus 300 downloads the required data from the external server. The playlist may be a progressive playlist, and thus, as described above, the data can be reproduced even if playlists that are to be reproduced are not fully downloaded. The controller 310 transmits the downloaded data in the local storage 360 to the signal processor 330, and the signal processor 330 decodes the received data and outputs the decoded data through the signal output unit 340. If the clip AV stream can be reproduced in operation 503, the apparatus 300 reproduces the clip AV stream in operation 513.

In operation 503, if a clip AV stream that is to be reproduced next cannot be reproduced, then in operation 505 the controller 310 stores information about a reproduction location of a clip AV stream that was last reproduced. The controller 310 stops data reproduction and simultaneously or later reads additional data pre-stored in the local storage 360 or the memory, and reproduces the additional data through the signal output unit 340, in operation 507. When the local storage 360 downloads data from an external server, the controller 310 determines whether the downloaded data is the clip AV stream that is to be reproduced next by using the information about the reproduction location, in operation 509. If the downloaded data is the clip AV stream that is to be reproduced next, the controller 310 stops reproducing the additional data in operation 511. Then, the controller 310 reproduces the clip AV stream that is to be reproduced next from where the data reproduction has stopped, in operation 513. Otherwise, the apparatus 300 continues to reproduce the additional data in operation 507.

As described above, when data that is to be reproduced cannot be reproduced because the data has not yet been downloaded or is not activated, additional data separate from the data can be provided to a user while the data is being downloaded. In addition, when data that is to be reproduced has not yet been downloaded in a local storage, data reproduction may be stopped, and when the downloading of the data that is to be reproduced is completed, the data reproduction from the downloaded data is automatically started.

Aspects of the present invention can also be embodied as computer readable codes on a computer readable recording medium. The computer readable recording medium is any data storage device that can store data which can be thereafter read by a computer system, a standalone special or general purpose computer, or one or more processors. Examples of the computer readable recording medium include read-only memory (ROM), random-access memory (RAM), CDs, DVDs, BDs, magnetic tapes, floppy disks, and optical data storage devices. The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of reproducing data, the method comprising:
downloading data a local storage; and
reproducing the downloaded data according to a predetermined reproduction order and a virtual file system created to reflect the downloaded data;
wherein if data that is to be reproduced next has not yet been downloaded, the reproducing of the data according to the predetermined reproduction order comprises:
stopping data reproduction;
detecting a location at which the data reproduction stopped; and
reproducing data from the location where data reproduction stopped once the downloading of the data that is to be reproduced next is completed.

2. The method of claim 1, wherein the reproducing of the data according to a predetermined reproduction order further comprises:
reproducing additional data that is pre-stored in the local storage after stopping the data reproduction; and
stopping the reproducing of the additional data once the downloading of the data that is to be reproduced next is completed.

3. The method of claim 2, wherein the downloading of data to the local storage comprises storing the data independently from the additional data in the local storage.

4. The method of claim 1, wherein:
the data reproduction is performed according to a progressive playlist unit; and
the stopping of data reproduction comprises stopping the reproducing of the clip AV streams if a clip AV stream that is to be reproduced next from among clip AV streams assigned by a playitem included in a progressive playlist has not yet been downloaded.

5. The method of claim 4, wherein:
the stopping of the data reproduction comprises storing information about a reproduction location of a clip AV stream that was last reproduced before stopping the data reproduction; and
the reproducing of data from the location where data reproduction stopped comprises reproducing the clip AV stream that is to be reproduced next from the reproduction location using the information about the reproduction location.

6. The method of claim 1, further comprising:
generating the virtual file structure to reproduce data read from a recording medium; and
when the data is downloaded in the local storage, updating the virtual file structure to include a structure of the downloaded data;
wherein the reproducing of the data comprises extracting a reproduction order of clip AV streams from a progressive playlist in the updated virtual file structure, and reproducing the clip AV streams according to the reproduction order.

7. An apparatus to reproduce data, the apparatus comprising:
a local storage to store data downloaded from an external server; and
a controller to reproduce the data stored in the local storage according to a predetermined reproduction order and a virtual file system that reflects the downloaded data;
wherein, when data that is to be reproduced next has not been downloaded, the controller stops data reproduction, detects a location at which the data reproduction stopped, and reproduces the data that was being stopped once the data that is to be reproduced next is downloaded.

8. The apparatus of claim 7, wherein the controller reproduces additional data pre-stored in the local storage after the data reproduction is stopped, and stops reproducing the additional data once the data that is to be reproduced next is downloaded.

9. The apparatus of claim 8, wherein:
the local storage stores the additional data that is separately stored from the data downloaded from the external server; and
the additional data is one of an AV data stream and an application program.

10. The apparatus of claim 7, wherein:
the data reproduction is performed according to a progressive playlist unit; and
when a clip AV stream that is to be reproduced next from among clip AV streams assigned by a playitem stored in a progressive playlist has not been downloaded from the local storage, the controller stops reproducing the clip AV streams.

11. The apparatus of claim 10, wherein the controller stores information about a reproduction location of a clip AV stream that was last reproduced before stopping the reproducing of the clip AV streams, and when the clip AV streams are again reproduced, reproducing the clip AV streams from the reproduction location by using the information.

12. The apparatus of claim 7, further comprising:
a reader to read data stored in a recording medium;
a signal processor to process a signal to reproduce the data stored in the recording medium and the local storage; and
an output unit to output the reproduced data,
wherein the controller generates a virtual file structure to reproduce the data read from the recording medium, updates the virtual file structure when the data that is to be reproduced next is downloaded from the local storage, extracts a reproduction order of clip AV streams that are to be reproduced from a progressive playlist in the updated virtual file structure, and reproduces the clip AV streams according to the reproduction order.

13. A computer readable recording medium having recorded thereon a program to execute a method of reproducing data, the method including:
downloading data in a local storage; and
reproducing the data according to a predetermined reproduction order and a virtual file system;
wherein, if data that is to be reproduced next has not yet been downloaded, the reproducing of the data according to the predetermined reproduction order comprises:
stopping data reproduction;
detecting a location at which the data reproduction stopped; and
reproducing data from the location where data reproduction stopped once the downloading of the data that is to be reproduced next is completed.

14. A method of reproducing data comprising:
reproducing data from a local storage unit according to a predetermined reproduction order while the data is being downloaded to the local storage unit in units from an external server;
determining that a reproducing error exists because a next unit of data to be reproduced has not yet been downloaded, or because an error is preventing reproduction of the downloaded data;
stopping reproduction of the data and determining a point in the data where reproduction of the data stopped;
reproducing additional data previously stored in the local storage unit while the reproducing error exists; and
when the reproducing error no longer exists, reproducing the data from the point where reproduction of the data stopped.

15. The method of claim 14, wherein the determining that the data to be reproduced has not yet been downloaded comprises determining that the data to be reproduced has not yet been downloaded if a clip AV stream that is to be reproduced next has not yet been fully downloaded.

16. The method of claim 14, further comprising:
generating a virtual file structure to reproduce data read from a recording medium; and
updating the virtual file structure when the data is downloaded to the local storage unit;
wherein the reproducing of the data comprises extracting a reproduction order of clip AV streams from a progressive playlist in the updated virtual file structure, and reproducing the clip AV streams according to the extracted reproduction order.

17. A reproduction and/or recording apparatus comprising:
a reproduction unit to reproduce data;
a local storage unit to store data downloaded from an external device;
a controller to control the reproduction unit to reproduce the data in units according to a predetermined reproduction order while the data is downloaded to the local storage unit from an external server, to determine that a reproducing error exists because the data to be reproduced has not yet been downloaded, or because an error is preventing reproduction of the downloaded data, to control the reproduction unit to stop the reproduction of the data and to reproduce additional data pre-stored in the local storage unit while the reproducing error exists, and, when the data reproducing error no longer exists, to control the reproduction unit to stop reproduction of the additional data and to resume reproducing the downloaded data from a point where reproduction stopped.

18. The reproduction and/or recording apparatus of claim 17, wherein, the controller determines that the data to be reproduced has not yet been downloaded if a clip AV stream that is to be reproduced next has not yet been downloaded.

19. The reproduction and/or reproducing apparatus of claim 17, further comprising:
a reading unit to read data from a recording medium;
wherein the controller generates a virtual file structure to reproduce data read from a recording medium, updates the virtual file structure when the downloaded data is downloaded to the local storage, extracts a reproduction order of clip AV streams from a progressive playlist in the updated virtual file structure, and controls the reproduction unit to reproduce the clip AV streams in the extracted reproduction order.

20. The reproducing and/or recording apparatus of claim 17, further comprising:
a reading unit to read the data from a recording medium;
wherein the controller generates a virtual file structure for the data read from the recording medium and downloaded from the external server, extracts a reproduction order of clip AV streams from a progressive playlist in the virtual file structure, and controls the reproduction unit to reproduce the clip AV streams in the extracted reproduction order.
